(19) United States
(12) Patent Application Publication
(10) Pub. No.: US 2019/0243383 A1
(43) Pub. Date: Aug. 8, 2019

(54) SYSTEMS AND METHODS FOR THE TRANSPORT AND STORAGE OF AUTONOMOUS GROUND VEHICLES

(71) Applicant: Walmart Apollo, LLC, Bentonville, AR (US)

(72) Inventors: Robert L. Cantrell, Herndon, VA (US); Brian G. McHale, Chadderton Oldham (GB)

(21) Appl. No.: 16/259,085

(22) Filed: Jan. 28, 2019

Related U.S. Application Data
(60) Provisional application No. 62/625,555, filed on Feb. 2, 2018.

(51) Int. Cl. G05D 1/02; G05D 1/00; B66F 9/12

(52) U.S. Cl. CPC G05D 1/0291; G05D 1/0088; G05D 2201/0213; G05D 2201/0216; B66F 9/12

(57) ABSTRACT

In some embodiments, apparatuses and methods are provided herein useful for the transport and storage of autonomous ground vehicles (AGVs) at commercial product distribution centers and shopping facilities. In some embodiments, the system includes at least one AGV with each AGV including a plurality of support members defining slots on the vehicle body of the AGV. The system may further include an AGV docking and storage facility including: a plurality of unique AGV storage locations; at least one set of fork arms, each set of fork arms configured for reception in the slots of the at least one AGV; an occupancy sensor to determine when an AGV can be loaded into a unique storage location; and a conveyor assembly configured to transport each AGV to a unique storage location.

### CROSS-REFERENCE TO RELATED APPLICATION

This application claims the benefit of U.S. Provisional Application No. 62/625,555, filed Feb. 2, 2018, which is incorporated by reference in its entirety herein.

### TECHNICAL FIELD

This invention relates generally to autonomous ground vehicles, and more particularly, to the transport and storage of autonomous ground vehicles.

### BACKGROUND

In the retail setting, autonomous ground vehicles are being used with ever increasing frequency. These autonomous ground vehicles may move about and operate in a programmed manner without the need for a human operator in many circumstances. Some of the uses for autonomous ground vehicles may include, for example, transporting merchandise to a customer or other destination or moving merchandise to different areas within a merchandise distribution center or a shopping facility.

With this ever increasing use, however, there is a need for efficient storage of these autonomous ground vehicles. Without efficient storage, when not in use, these vehicles may tend to clutter retail areas and interfere with the movement of other vehicles and people. Accordingly, there is a need for the convenient transport and storage of autonomous ground vehicles at stores and distribution centers when they are not in use.

### BRIEF DESCRIPTION OF THE DRAWINGS

Disclosed herein are embodiments of systems, apparatuses and methods pertaining to the loading and unloading of merchandise using a plurality of autonomous ground vehicles. This description includes drawings, wherein:

FIG. 1 is a schematic diagram in accordance with some embodiments;

FIG. 2 is a block diagram in accordance with some embodiments;

FIGS. 3A, 3B, 3C, 3D, and 3E are schematic diagrams in accordance with some embodiments;

FIGS. 4A and 4B are schematic diagrams in accordance with some embodiments;

FIGS. 5A and 5B are schematic diagrams in accordance with some embodiments;

FIG. 6 is a schematic diagram in accordance with some embodiments;

FIGS. 7A, 7B, and 7C are schematic diagrams in accordance with some embodiments;

FIG. 8 is a block diagram in accordance with some embodiments;

FIG. 9 is a schematic diagram in accordance with some embodiments;

FIG. 10 is a schematic diagram in accordance with some embodiments;

FIG. 11 is a block diagram in accordance with some embodiments; and

FIG. 12 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for facilitating the transport and storage of autonomous ground vehicles at commercial product distribution centers and shopping facilities. In some embodiments, there is provided a system comprising: at least one autonomous ground vehicle (AGV), each AGV comprising: a vehicle body; a motorized locomotion system configured to facilitate movement of the AGV; a navigational system for guiding the movement of the AGV; a power source disposed in the vehicle body and configured to energize movement and operation of the AGV; a plurality of support members defining slots disposed on the vehicle body, the slots configured for reception of fork arms therein for moving the AGV; an alignment sensor configured to facilitate aligning the slots with fork arms; a merchandise storage area configured to facilitate transport of merchandise; an AGV control circuit operatively coupled to the motorized locomotion system, the navigational system, the power source, and the alignment sensor, the control circuit configured to operate and move the AGV; and an AGV docking and storage facility including: a plurality of unique AGV storage locations; at least one set of fork arms, each set of fork arms configured for reception in the slots of the at least one AGV; an occupancy sensor to determine when an AGV can be loaded into a storage location; and a conveyor assembly configured to transport each AGV to a unique storage location.

In the system, in some implementations, the motorized locomotion system of each AGV further comprises two sets of wheels; and the plurality of support members of each AGV are disposed on an underside of the vehicle body between the two sets of wheels. In some implementations, the plurality of support members of each AGV are removably affixed to the vehicle body. In some implementations, the plurality of support members of each AGV are pivotably affixed to the vehicle body for folding the support members into the vehicle body or are configured for retraction into the vehicle body. In some implementations, the plurality of slots of each AGV comprise: a first set of slots disposed on an underside of the body and extending in a first direction; and a second set of slots disposed on the underside of the body and extending in a second direction that is perpendicular to the first direction. In some implementations, the plurality of support members of each AGV are electrically conductive to allow charging of the power source of each AGV. In some implementations, the at least one set of fork arms comprises a plurality of sets of fork arms, each set of fork arms defining a storage and charging area for an AGV and each set configured to support the AGV, charge the power source of the AGV, and lock the AGV to the set of fork arms. In some implementations, the plurality of support members of each AGV comprise two support members with each support member being tubular in shape and defining a rectangular bore therein. In some implementations, the plurality of support members of each AGV are composed, at least in part, of carbon fiber, graphene, aluminum, fiberglass, or wood.

In another form, there is provided a method for facilitating the transport and storage of autonomous ground vehicles at commercial product distribution centers and shopping facilities, the system comprising: providing at least one autonomous ground vehicle (AGV), each AGV comprising: a vehicle body; a motorized locomotion system configured to facilitate movement of the AGV; a navigational system for guiding the movement of the AGV; a power source disposed in the vehicle body and configured to energize movement and operation of the AGV; a plurality of support members defining slots disposed on the vehicle body, the slots configured for reception of fork arms therein for moving the AGV; an alignment sensor configured to facilitate aligning the slots with fork arms; a merchandise storage area configured to facilitate transport of merchandise; an AGV control circuit operatively coupled to the motorized locomotion system, the navigational system, the power source, and the alignment sensor, the control circuit configured to operate and move the AGV; and providing an AGV docking and storage facility including: a plurality of unique AGV storage locations; at least one set of fork arms, each set of fork arms configured for reception in the slots of the at least one AGV; an occupancy sensor to determine when a unique storage location is occupied; and a conveyor assembly configured to transport each AGV to a unique storage location; moving an AGV adjacent to the AGV docking and storage facility; aligning, by the alignment sensor, the slots of the AGV with a set of fork arms of the AGV docking and storage facility; determining, by the occupancy sensor, that the AGV can be loaded into one of the unique storage locations; moving the AGV such that the set of fork arms are received in the AGV's slots; transporting, by the conveyor assembly, the AGV to an unoccupied unique storage location.

In another form, there is provided a system for facilitating the transport of autonomous ground vehicles at distribution centers and shopping facilities, the system comprising: at least one autonomous ground vehicle (AGV), each AGV comprising: a vehicle body; a motorized locomotion system configured to facilitate movement of the AGV; a navigational system for guiding the movement of the AGV; a power source disposed in the vehicle body and configured to energize movement and operation of the AGV; a plurality of support members defining slots disposed on the vehicle body, the slots configured for reception of fork arms therein for moving the AGV; a merchandise storage area configured to facilitate transport of merchandise; and an AGV control circuit operatively coupled to the motorized locomotion system, the navigational system, and the power source, the control circuit configured to operate and move the AGV.

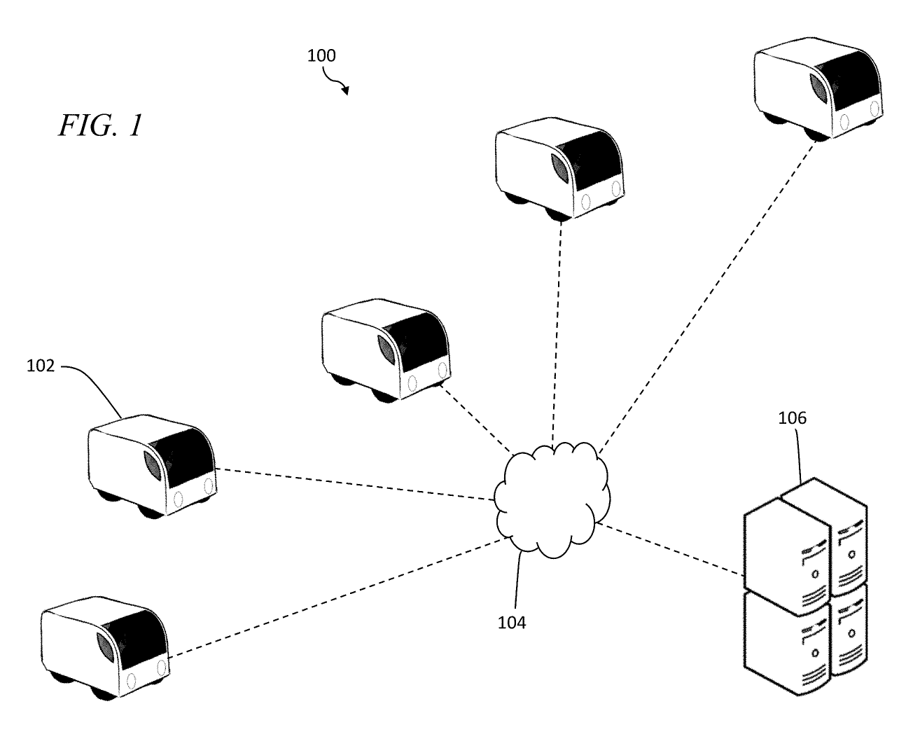

Referring to FIG. 1, there is shown a system 100 in which multiple AGVs 102 move about and operate, such as, for example, at a merchandise distribution center or a shopping facility. The AGVs 102 may perform various tasks at the merchandise distribution center or store involving the transport of merchandise items. For example, these tasks may include moving merchandise to different inventory locations within the distribution center or store or delivering the merchandise to a customer. In the system 100, to facilitate the performance of tasks, the AGVs 102 may communicate over a network 104. The system 100 may include a central computer system 106 accessible by one or more of the AGVs 102 over the network 104.

In certain circumstances, it is contemplated that the AGVs 102 may need to be moved about (such as, for example, when their batteries are depleted) and/or stored at the distribution centers and shopping facilities. It is desirable to be able to store the AGVs 102 when they are not in use. It is generally contemplated herein that the AGVs 102 can be lifted by forklifts at the distribution center or store or by forks/fork arms that may be part of a docking station at the distribution center or store.

As described further below, the system 100 is directed generally to equipping the AGVs 102 with slots such that a forklift may insert its forks/fork arms through the slots and lift each AGV 102. The slots may be located on the undercarriage of the AGV 102 and may be retractable, foldable, or removable. They can be oriented in either the front-to-back or side-to-side orientations or can accommodate both orientations to lift from back, front, and the sides (cross-ways arrangement). AGVs 102 can then be picked up by the forklift and moved or stored above or below ground level or loaded onto other transport vehicles. Stationary forklifts can be used as elevators for front-to-back slot configurations where an AGV 102 drives into the forks. The forks/fork arms may also conduct electricity or otherwise be fashioned so as to allow charging of the battery of an AGV.

The forks or fork arms used to lift the AGV 102, however, need not be part of a forklift vehicle. The system 100 is also directed to using the forks or fork arms at a docking station for the storage of multiple AGVs 102. The system 100 may use forks or fork arms (not part of a vehicle) to separately lift a number of AGVs 102 and may use conveyer systems, for example, to move the AGVs 102 to specific storage locations. To support the automated loading into a storage location or bay, the system 100 may use additional sensors with the forks so that the system 100 can determine when to start and stop loading the AGV 102. When in storage, the batteries/cells of the AGVs 102 can be recharged.

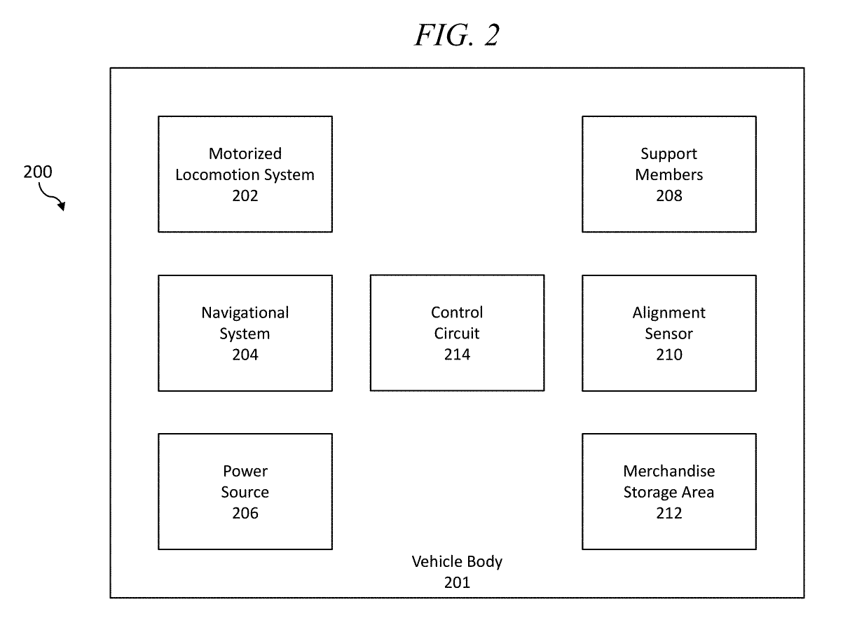

Referring now to FIG. 2, an AGV 200 for use in transporting/conveying merchandise in accordance with some embodiments is shown. It is generally contemplated that the AGV 200 includes certain components that allow it to convey merchandise and to operate at distribution centers and shopping facilities. The AGV 200 includes a vehicle body 201 housing a motorized locomotion system 202, a navigational system 204, a power source 206, a plurality of support members 208 defining slots 216, an alignment sensor 210, a merchandise storage area 212, and a control circuit 214. It is generally contemplated that the AGVs 200 are generally interchangeable with one another, but it is also contemplated that some of the AGVs 200 may have different characteristics that make their use especially appropriate in certain circumstances.

The AGV 200 includes a motorized locomotion system 202 configured to facilitate movement of the AGV 200. It is generally contemplated that the motorized locomotion system 202 may include wheels 224 (or tracks or legs), a motor, and a drive mechanism. For example, in one preferred form, the motorized locomotion system 202 of each AGV 200 includes two sets of wheels 224. The AGVs 200 also each include a power source 206 (such as a battery or solar cell) disposed in the vehicle body 201 and configured to energize movement and operation of the AGV 200, i.e., to energize the AGV's motorized locomotion system 202 and other components. The motorized locomotion system 202 may comprise one or more motors that control one or more of a speed, direction, and/or orientation of one or more wheels 224 (or tracks or legs) on the AGV 200. The motorized locomotion system 202 may be configured to be controlled by the control circuit 214 to move the AGV 200 in designated directions.

The AGV 200 includes a navigational system 204 for guiding movement of the AGV 200. The navigational system 204 includes sensor(s) for navigation and optionally for detecting obstacles in the AGV's path as it travels along its route. These sensor(s) may be of any of various types, including global positioning systems (GPS), compasses and other navigational aids, gyroscopes, magnetometers, accelerometers, radar laser range finders, ultrasound range finders, infrared sensors, and optical/imaging sensors (such as video/camera devices). It is also generally contemplated that the optical/imaging sensors may permit a human operator to remotely guide the AGV 200. As part of and in addition to the navigational sensors, the AGV 200 may also include sensor(s) for determining the AGV's position relative to other objects. These sensor(s) aid in the avoidance of objects as the AGV 200 moves about a product distribution center or shopping facility.

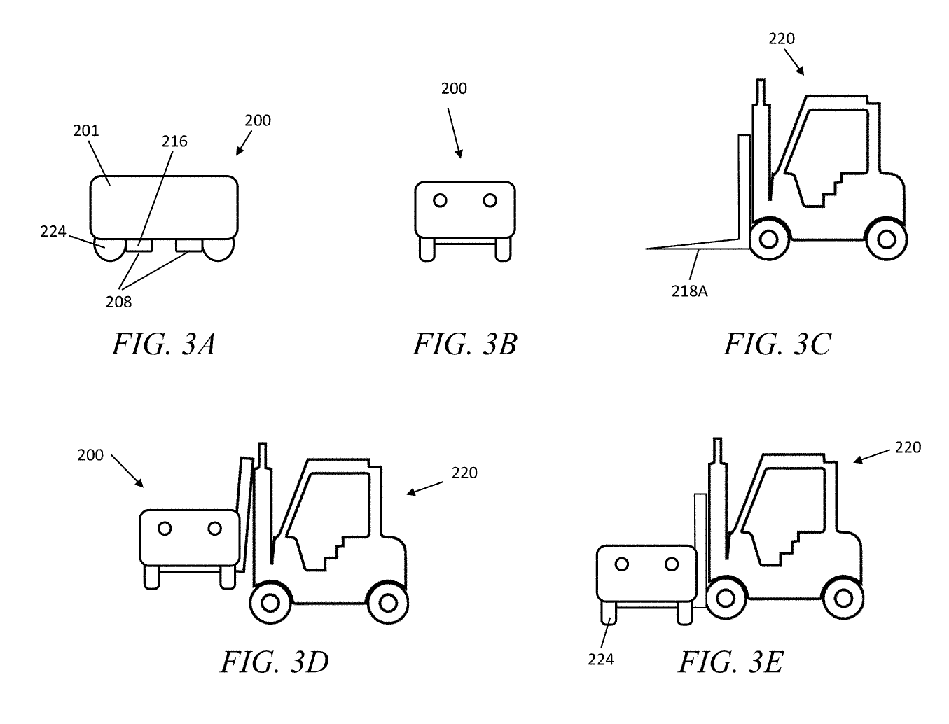

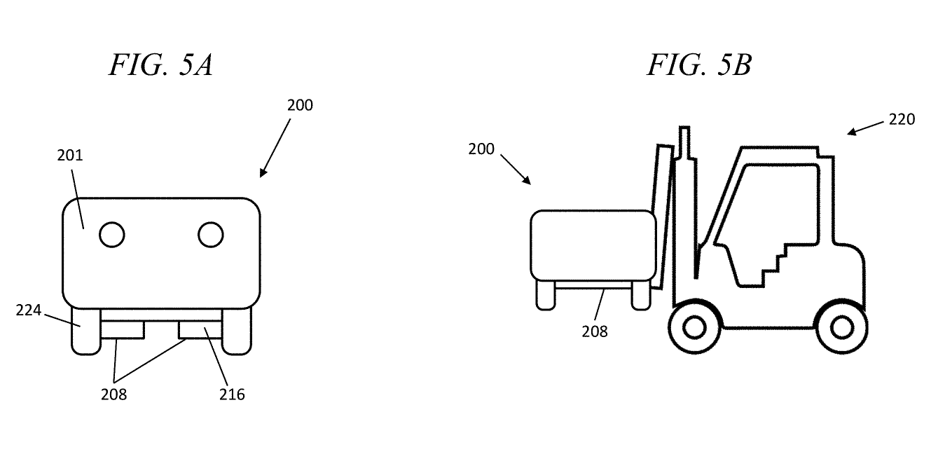

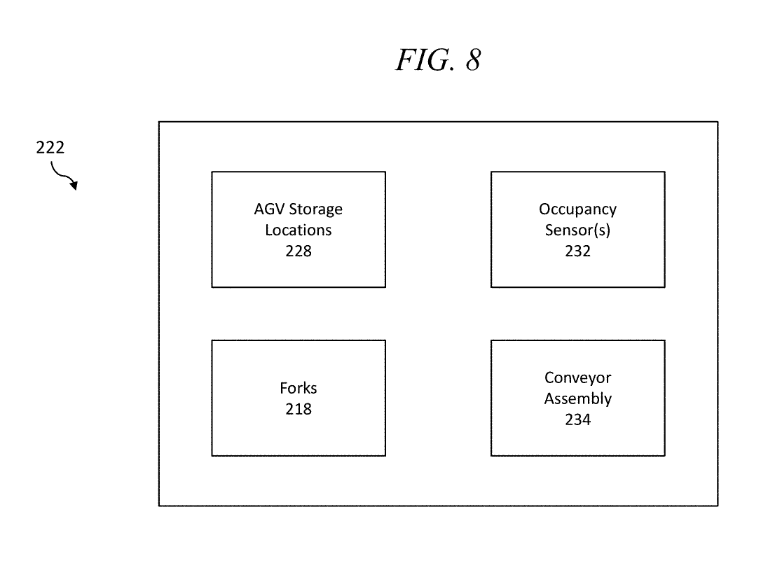

As shown in FIGS. 3-10, each AGV 200 also includes a plurality of support members 208 defining slots 216 that are preferably disposed on the underside of the vehicle body 201, and these slots 216 are configured for reception of forklift arms/forks 218 therein for lifting and moving the AGV 200. It is generally contemplated that these slots 216 may receive the forklift arms 218A of a forklift 220 (FIGS. 3C, 3D, 3E, and 5B) or may receive the fork arms or forks 218B of a docking station (or AGV docking and storage facility) 222 (FIGS. 8-10). In one preferred form, the plurality of support members 208 of each AGV 200 are disposed on the underside of the vehicle body 201 between two sets of wheels 224, although it should be understood that the plurality of support members 208 defining slots 216 may be located at various areas on the AGV 200. Further, as one example, the support members 208 may include two support members 208 with each support member 208 being tubular in shape and defining a rectangular bore therein, although it should be understood that the support members 208 may be any of a variety of shapes suitable for receiving forks/forklift arms 218 therein.

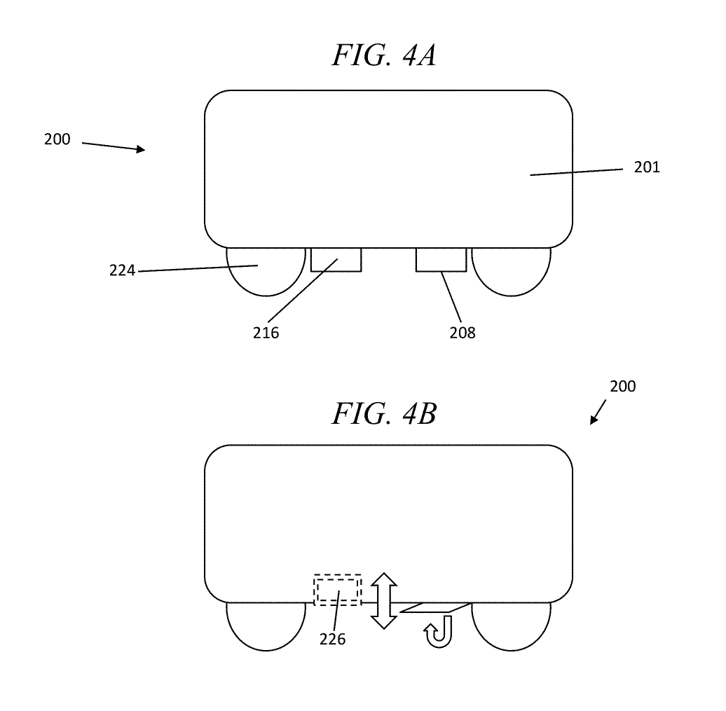

In addition, it should be understood that the support members 208 may be mounted to the AGV 200 in a variety of ways. As a first example, the support members 208 may be fixedly and rigidly fastened to the AGV 200 (such as by nails, screws, or other fasteners) so that they are relatively permanently and immovably installed. Alternatively, as a second example, the support members 208 of each AGV 200 may be removably affixed to the vehicle body 201, such as by hooks, clips, or other such fasteners, to allow for convenient removal and temporary installation of the support members 208. Further, as a third example (shown in FIG. 4B), the plurality of support members 208 of each AGV 200 may be pivotably or foldably affixed to the vehicle body 201 for folding the support members 208 into or against the vehicle body 201, or they may be configured for retraction into the vehicle body 201. In this third example, for instance, the underside of the vehicle body 201 may further include recesses 226 for receiving the support members 208 (when the support members 208 are not in use). The control circuit 214 may be coupled to the support members 208 to cause the movement, i.e., pivoting, folding, or retraction, of the support members 208 into or against the vehicle body 201 (and to cause the movement of the support members 208 back to an operational position).

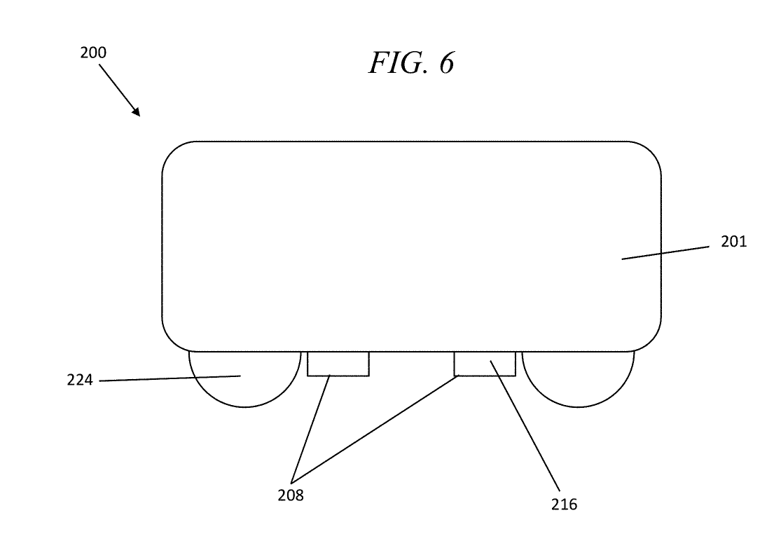

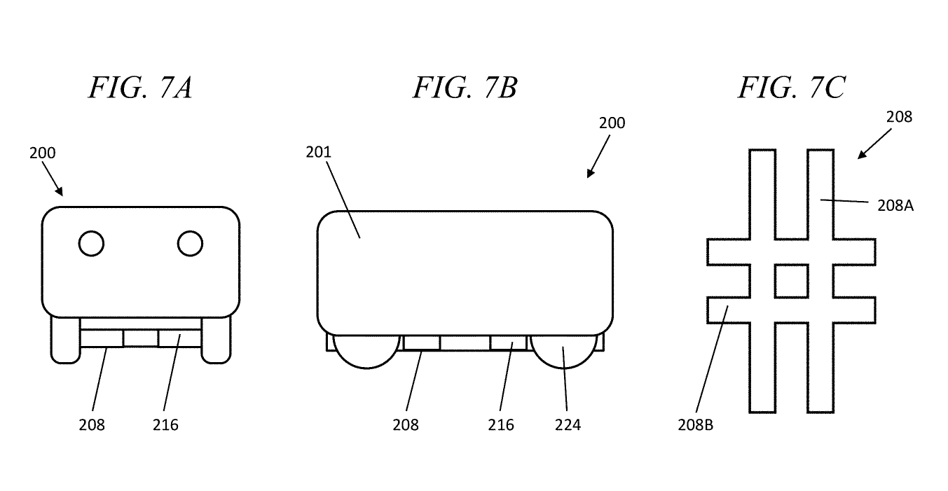

Further, it should be understood that the support members 208 (defining the slots 216) may be configured and arranged in a variety of ways. For example, the support members 208 and slots 216 may be arranged to extend from the front of the AGV 200 to the back of the AGV 200 (FIGS. 5A and 5B) or may be arranged to extend from one side of the AGV 200 to the other side (FIG. 6). In one form, as shown in FIGS. 7A, 7B, and 7C, there may be two sets of support members 208 with one set 208A extending in a front-to-back arrangement and the second set 208B extending in a side-to-side arrangement. In other words, the plurality of slots 216 of each AGV 200 may include a first set of slots 216 disposed on the underside of the body and extending in a first direction, i.e., front-to-back, and a second set of slots 216 disposed on the underside of the body 201 and extending in a second direction, i.e., side-to-side, that is perpendicular to the first direction.

It should also be understood the support members 208 may be composed of various materials. For example, in one preferred form, the support members 208 may be partially or wholly composed of carbon fiber, graphene, aluminum, fiberglass, and/or wood. The support members may also be partially or wholly of ceramic, polymer, steel, other metals. Further, in one form, the composition of the material of the support members 208 may be selected so as to facilitate the charging of the power source 206 of the AGV 200. In other words, the plurality of support members 208 of each AGV 200 may be electrically conductive to allow charging of the power source 206 of each AGV 200. In this circumstance, the forklift arms/forks 218 may similarly be configured and composed of material suitable for conducting electrical charge for charging the power source 206.

In addition, the AGV 200 includes an alignment sensor 210 for facilitating alignment of the support members 208 and slots 216 with forks/forklift arms 218. It is generally contemplated that the AGV 200 needs alignment sensor(s) 210 in order to properly position itself with respect to the forks of a docking station 222 (addressed further below). These alignment sensor(s) 210 may be any of various types and in various configurations. For example, they may include optical sensors, reflectors, magnets, lasers, sensors previously addressed in this disclosure, etc.

The AGV 200 includes a merchandise storage area 212, such as a storage compartment, that may be suited to carrying merchandise and/or other types of cargo. As should be evident, the storage area 212 may be any of various physical sizes and geometries. In one form, it is generally contemplated that the merchandise storage area 212 may be a storage compartment formed in the interior of the vehicle body 201 that may be removably covered by a lid of the compartment. It is generally contemplated that the AGV 200 with a storage area 212 is used to transport merchandise within distribution centers and/or stores (and/or may transport merchandise from distribution centers and stores to customers).

In addition, the AGV 200 includes a control circuit 214 operatively coupled to the motorized locomotion system 202, the navigational system 204, the power source 206, and the alignment sensor 210 (and optionally to the support members 208 and merchandise storage area 212). The control circuit 214 is configured to operate and move the AGV 200. The control circuit 214 may comprise a processor, a microprocessor, and the like and may be configured to execute computer readable instructions stored on a computer readable storage memory. The computer readable storage memory may comprise volatile and/or non-volatile memory and have stored upon it a set of computer readable instructions which, when executed by the control circuit 214, cause the control circuit 214 to navigate the AGV 200 and communicate with other devices. The architectural options for such structures are well known and understood in the art and require no further description here. The control circuit 214 is configured (for example, by using corresponding programming as will be well understood by those skilled in the art) to carry out one or more of the steps, actions, and/or functions described herein.

The AGV 200 may further include a transceiver configured for wireless communication. The transceiver may comprise one or more of a WLAN transceiver, a WWAN transceiver, a mobile data network transceiver, a satellite network transceiver, a WiMax transceiver, a Wi-Fi transceiver, a Bluetooth transceiver, and the like. In some embodiments, the transceiver may be configured to allow the control circuit 214 to communicate with the other AGVs 200 and a central computer system.

In addition to the AGVs 200, the system 100 further includes an AGV docking and storage facility or docking station 222. As addressed above, in one form, it is generally contemplated that the AGVs 200 are transporting merchandise at and about merchandise distribution centers and stores, i.e., they are transporting merchandise to different areas within a distribution center or store and/or they are transporting merchandise to and from the distribution center or store (such as delivering ordered merchandise to a customer). In this context, it is generally contemplated that the AGVs 200 will need to be stored and their power sources 206 recharged, such as at a docking and storage facility 222.

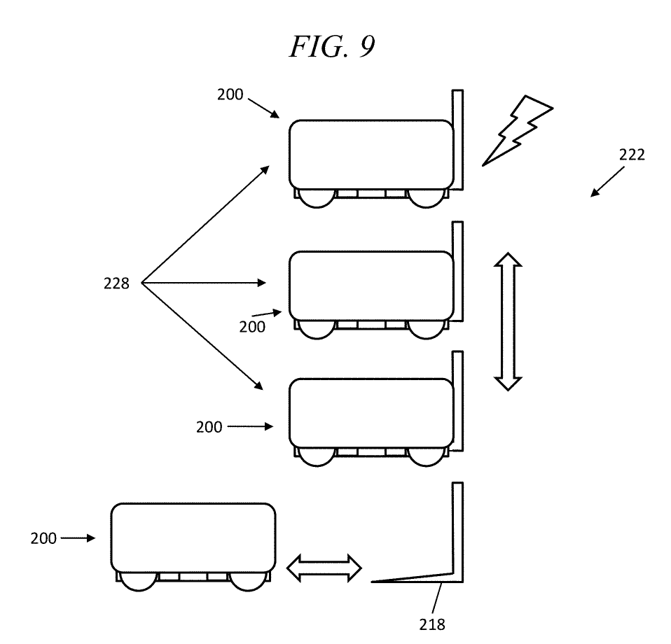

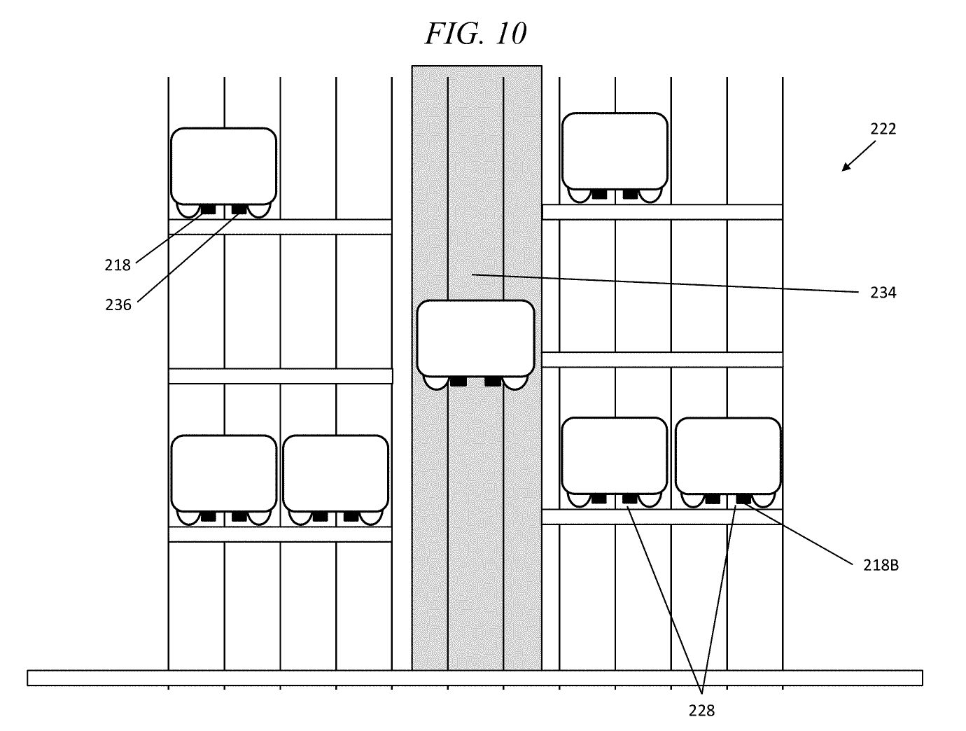

Referring to FIG. 8, the AGV docking and storage facility 222 includes a plurality of unique AGV storage locations 228, at least one set of forks 218, one or more occupancy sensors 232, and a conveyor assembly 234. The AGV docking and storage facility 222 may take various forms. As shown in FIG. 9, in one simple form, the docking and storage facility 222 is in the form of a storage rack or elevator in which the AGVs 200 are raised and stored at different elevations. As shown in FIG. 10, in another form, the docking and storage facility 222 includes a conveyor assembly 234 that allows up-and-down and lateral movement and storage of AGVs 200 such that multiple AGVs 200 may be stored next to each other at the same elevation. As should be evident, there are a numerous variety of different possible physical configurations of the AGV docking and storage facility 222.

The docking and storage facility 222 includes at least one set of forks 218, and each set of forks 218 is configured for reception in the slots of the AGVs 200. For example, in one form, the docking and storage facility 222 may include just one set of forks 218 (which may be two forks 218). An AGV 200 may load itself onto this one set of forks 218, which may then move and deposit the AGV 200 at a unique storage location 228. In this example, one set of forks 218 performs all of the lifting and moving operation. In another form, however, the AGV docking and storage facility 222 may include multiple sets of forks 218 with each set of forks 218 corresponding to a unique storage location 228. In this example, each set of forks 218 will move an AGV 200 to the corresponding unique storage location 228 and may support the AGV 200 while the AGV 200 is stored in the unique storage location 228.

The AGV docking and storage facility 222 further includes one or more occupancy sensors 232 to help determine when an AGV 200 can be loaded into a unique storage location 228. For example, in one form, multiple sets of forks 218 may be used that are each intended to support an AGV 200 in the storage locations 228. In this form, each set of forks 218 may be equipped with an occupancy sensor 232 so that it is known when a particular set of forks 218 is in use, i.e., supporting an AGV 200. In another form, one set of forks may be used to transport an AGV 200 to a unique storage location 228 on a storage shelf. In this form, each unique storage location 228 may be equipped with a corresponding occupancy sensor 232, or the storage shelf itself may be equipped with one or more occupancy sensors 232, in order to determine the occupancy of the storage location 228 or shelf. Any of various types of occupancy sensors may be used, and in one preferred form, weight sensors (or pressure or load sensors) may be used to determine if the space is occupied (by something) and further may be calibrated to confirm that the occupying object is an AGV 200 (by determining that the occupying objection is within the predetermined weight range for an AGV 200). As another example, the occupancy sensors 232 may be in the form of motion detecting sensors (e.g., lasers) arranged at certain points about the unique storage locations 228, which may, for example, detect an interruption or break in the sensor's signal indicating that a unique storage location 228 is now being occupied.

The docking and storage facility 222 also includes a conveyor assembly 234 configured to transport each AGV 200 to a unique storage location 228. In one embodiment, this conveyor assembly 234 may be in the form of a vertical elevator that lifts and transports AGVs 200 to different elevations for storage. In another embodiment, the conveyor assembly 234 provides for both vertical and lateral movement so as to store multiple AGVs 200 on the same storage shelf (at the same elevation).

It is also contemplated that the docking and storage facility 222 may be configured so as to charge the power source 206 of each AGV 200 while the AGV 200 is conveniently not in use. In one form, each set of forks 218 may be equipped with a locking mechanism 236 to secure the AGV 200 in place while in the docking facility 222. In other words, each set of forks 218 may individually define a storage and charging area for an AGV 200, and each set may be configured to support the AGV 200, charge the power source of the AGV 200, and lock the AGV 200 to the set of forks 218. In another form, a set of forks 218 may be used to removably deposit an AGV 200 in each unique storage location 228, and the unique storage location 228 may be equipped with a separate charging device to charge the AGV's power source 206 and/or a locking mechanism 236 to secure the AGV 200 in the storage location 228.

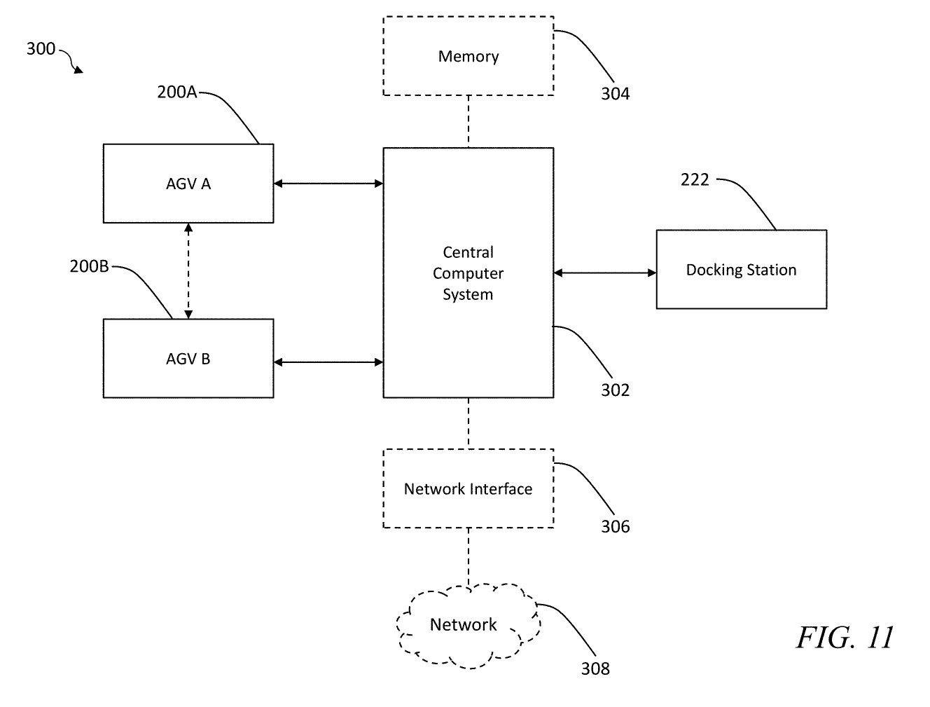

Referring now to FIG. 11, it is shown that the docking station 222 (or docking and storage facility 222) may be part of and incorporated within an overall system 300 at the merchandise distribution center or shopping facility. More specifically, the docking station 222 may be coupled to a central computer system 302 that generally monitors and controls the operation of the docking station 222. In turn, the central computer system 302 may be communicatively coupled to multiple AGVs 200, such as, for example, AGV A (200A) and AGV B (200B) shown in FIG. 11 that may also communicate with one another. As should be evident, it is contemplated that additional AGVs may be used in the system 300. It is generally contemplated that the central computer system 302 may instruct the AGVs 200 to perform various tasks at the distribution center and stores, such as, for example, instructing the AGVs 200 to leave the distribution center/store and deliver merchandise to customers.

As described herein, the language “central computer system” refers broadly to a system including any microcontroller, computer, or processor-based devices with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The central computer system 302 may be configured (for example, by using corresponding programming stored in a memory as will be well understood by those skilled in the art) to carry out one or more of the steps, actions, and/or functions described herein.

As shown in FIG. 11, the central computer system 302 may be coupled to a memory 304, a network interface 306, and network(s) 308. The memory 304 can, for example, store non-transitorily computer instructions that cause the central computer system 302 to operate as described herein, when the instructions are executed, as is well known in the art. Further, the network interface 306 may enable the central computer system 302 to communicate with other elements (both internal and external to the system 300). This network interface 306 is well understood in the art. The network interface 306 can communicatively couple the central computer system 302 to whatever network or networks 308 may be appropriate for the circumstances. In this form, it is contemplated that the central computer system 302 may access one or more databases to collect data for performing its functions.

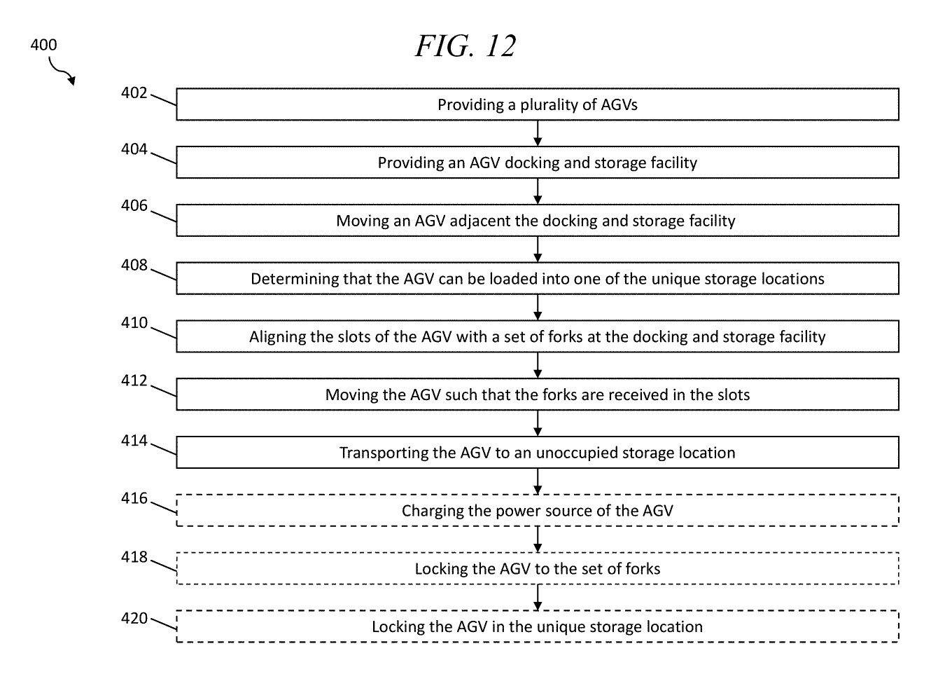

Referring to FIG. 12, there is shown a process 400 for moving and storing a plurality of AGVs at an AGV docking and storage facility. It is generally contemplated that this transport and storage occurs at a merchandise distribution center or shopping facility and that the AGVs may be used to perform any of various tasks at the distribution center or shopping facility. The process 400 may use the AGV 200 described above (and any of its components) and the docking and storage facility 222 described above (and any of its components).

At block 402, a plurality of AGVs 200 are provided. Each AGV generally includes the following components: a vehicle body; a motorized locomotion system for movement of the AGV; a navigational system for guiding the movement of the AGV; a power source disposed in the vehicle body for energizing movement and operation of the AGV; a plurality of support members defining slots disposed on the vehicle body with the slots being configured to receive arms therein for moving the AGV; an alignment sensor to facilitate aligning the slots with the forks; a merchandise storage area for facilitating transport of merchandise; and an AGV control circuit operatively coupled to the motorized locomotion system, the navigational system, the power source, and the alignment sensor, and the control circuit configured to operate and move the AGV. These AGVs may be intended to perform any of various tasks, such as, for example, delivering merchandise from the distribution center or store to a customer's residence or business.

At block 404, an AGV docking and storage facility is provided. The facility includes the following components: a plurality of unique AGV storage locations; at least one set of forks with each set of forks being configured to be received in the slots of an AGV; one or more occupancy sensors to determine when a unique storage location is occupied; and a conveyor assembly configured to transport each AGV to a unique storage location. It is contemplated that the docking and storage facilities may take the shape and form of any one of various physical configurations, such as, for example, a vertical elevator or a number of storage shelves at different elevations.

At block 406, an AGV is moved adjacent to the AGV docking and storage facility. It is generally contemplated that the AGV may autonomously transport itself to the docking and storage facility, although it may also be controlled and operated remotely by a central computer system or by a human operator. Further, it is contemplated that there may be a condition that triggers the AGV to be moved to the facility, such as, for example, detection of a low battery condition. Alternatively, the AGV may be triggered to move to the docking and storage facility at predetermined times or time intervals.

At block 408, it is determined whether the AGV can be loaded into one of the unique storage locations at the facility. It is generally contemplated that one or more occupancy sensors may be used to make this determination. In one form, one or more forks at the facility may include an occupancy sensor to determine whether that set of forks is already loaded with an AGV. In another form, it is contemplated that the unique storage locations themselves (or storage shelves at the facility) may include occupancy sensors to determine if the storage locations or shelves are occupied. Further, in one form, if it is determined that the facility is fully occupied with AGVs (and no empty storage locations are available), the AGV may be programmed or instructed to wait for a storage location to become available or to proceed to an alternative location for storage.

At block 410, the slots of the AGV are aligned with a set of forks at the docking and storage facility. In one form, this alignment may occur after it is determined that an empty storage location is available at the docking station. It is generally contemplated that the AGV uses its alignment sensor to properly align with the forks at the docking facility. At block 412, once aligned, the AGV is moved such that the forks are received in the slots. It is contemplated that additional positioning/location sensors may be used to confirm that the AGV is fully received on the slots (and is not only partially received).

At block 414, the AGV is transported to an unoccupied storage location. In one form, it is contemplated that the docking and storage facility may be operated and controlled by a central computer system, and this central computer system may determine and select the unoccupied storage location. Further, in some forms, the AGV may remain on the transporting forks while in the unoccupied storage location, while in other forms, the forks may be removed from the slots in order to deposit the AGV in the unoccupied storage location.

At block 416, optionally, the power source of the AGV may be charged while the AGV is in the storage location. In one form, if the AGV remains on the forks, it is contemplated that the forks may be electrically conductive and this charging will therefore occur via the forks. In another form if the AGV is removed from the forks, it is contemplated that the AGV will be charged by a power source at the storage location. It is generally contemplated that the docking facility provides a convenient area for charging the AGVs.

At block 418, optionally, the AGVs are locked to the forks. This locking may occur when the AGV first moves onto the forks, but this locking to the forks may also occur at a later time, such as after transport to the storage location. A locking mechanism may secure the AGV to the forks and prevent falling or other unintended and possibly harmful removal of the AGV. In addition, the locking mechanism may help prevent against theft or damage from a dynamic environment (such as earthquakes). At block 420, optionally, if the AGV is removed from the forks and deposited in the storage location, the AGV may be separately secured in the storage location.

The embodiments described above have generally involved a docking and storage facility. However, it should be understood that, in another embodiment, the AGVs may use support members defining slots that receive forklift arms but that do not use a docking and storage facility. In this form, for example, it may be sufficient that forklifts can be used to lift and transport AGVs in certain circumstances, such as to move them when the AGV power source is depleted or to simply stack the AGVs on top of one another in a storage area (when not in use). In another form, the forks/forked arms may be used as an elevator to allow an AGV to drive onto the forks and to then be transported to different floors of a distribution center or store, and in this instance, would not necessarily be used for storage of the AGV.

In this embodiment, it is generally contemplated that the AGV includes the same general components and characteristics described above. More specifically, each AGV generally includes: a vehicle body; a motorized locomotion system configured to facilitate movement of the AGV; a navigational system for guiding the movement of the AGV; a power source disposed in the vehicle body and configured to energize movement and operation of the AGV; a plurality of support members defining slots disposed on the vehicle body, the slots configured for reception of fork arms therein for moving the AGV; a merchandise storage area configured to facilitate transport of merchandise; and an AGV control circuit operatively coupled to the motorized locomotion system, the navigational system, the power source, and the one or more sensors, the control circuit configured to operate and move the AGV. In this particular embodiment, however, it is contemplated that the AGV may not include an alignment sensor (this component is optional) because a forklift operator may perform the alignment manually in many circumstances.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for facilitating the transport and storage of autonomous ground vehicles at commercial product distribution centers and shopping facilities, the system comprising:
at least one autonomous ground vehicle (AGV), each AGV comprising:
a vehicle body;
a motorized locomotion system configured to facilitate movement of the AGV;
a navigational system for guiding the movement of the AGV;
a power source disposed in the vehicle body and configured to energize movement and operation of the AGV;
a plurality of support members defining slots disposed on the vehicle body, the slots configured for reception of fork arms therein for moving the AGV;
an alignment sensor configured to facilitate aligning the slots with fork arms;
a merchandise storage area configured to facilitate transport of merchandise;
an AGV control circuit operatively coupled to the motorized locomotion system, the navigational system, the power source, and the alignment sensor, the control circuit configured to operate and move the AGV; and
an AGV docking and storage facility including:
a plurality of unique AGV storage locations;
at least one set of fork arms, each set of fork arms configured for reception in the slots of the at least one AGV;
an occupancy sensor to determine when an AGV can be loaded into a storage location; and
a conveyor assembly configured to transport each AGV to a unique storage location.

2. The system of claim 1, wherein:
the motorized locomotion system of each AGV further comprises two sets of wheels; and
the plurality of support members of each AGV are disposed on an underside of the vehicle body between the two sets of wheels.

3. The system of claim 1, wherein the plurality of support members of each AGV are removably affixed to the vehicle body.

4. The system of claim 1, wherein the plurality of support members of each AGV are pivotably affixed to the vehicle body for folding the support members into the vehicle body or are configured for retraction into the vehicle body.

5. The system of claim 1, wherein the plurality of slots of each AGV comprise:
a first set of slots disposed on an underside of the body and extending in a first direction; and
a second set of slots disposed on the underside of the body and extending in a second direction that is perpendicular to the first direction.

6. The system of claim 1, wherein the plurality of support members of each AGV are electrically conductive to allow charging of the power source of each AGV.

7. The system of claim 1, wherein the at least one set of fork arms comprises a plurality of sets of fork arms, each set of fork arms defining a storage and charging area for an AGV and each set configured to support the AGV, charge the power source of the AGV, and lock the AGV to the set of fork arms.

8. The system of claim 1, wherein the plurality of support members of each AGV comprise two support members with each support member being tubular in shape and defining a rectangular bore therein.

9. The system of claim 1, wherein the plurality of support members of each AGV are composed, at least in part, of carbon fiber, graphene, aluminum, fiberglass, or wood.

10. A method for facilitating the transport and storage of autonomous ground vehicles at commercial product distribution centers and shopping facilities, the system comprising:
providing at least one autonomous ground vehicle (AGV), each AGV comprising:
a vehicle body;
a motorized locomotion system configured to facilitate movement of the AGV;
a navigational system for guiding the movement of the AGV;
a power source disposed in the vehicle body and configured to energize movement and operation of the AGV;
a plurality of support members defining slots disposed on the vehicle body, the slots configured for reception of fork arms therein for moving the AGV;
an alignment sensor configured to facilitate aligning the slots with fork arms;
a merchandise storage area configured to facilitate transport of merchandise;
an AGV control circuit operatively coupled to the motorized locomotion system, the navigational system, the power source, and the alignment sensor, the control circuit configured to operate and move the AGV; and
providing an AGV docking and storage facility including:
a plurality of unique AGV storage locations;
at least one set of fork arms, each set of fork arms configured for reception in the slots of the at least one AGV;
an occupancy sensor to determine when a unique storage location is occupied; and
a conveyor assembly configured to transport each AGV to a unique storage location;
moving an AGV adjacent to the AGV docking and storage facility;
aligning, by the alignment sensor, the slots of the AGV with a set of fork arms of the AGV docking and storage facility;
determining, by the occupancy sensor, that the AGV can be loaded into one of the unique storage locations;
moving the AGV such that the set of fork arms are received in the AGV's slots;
transporting, by the conveyor assembly, the AGV to an unoccupied unique storage location.

11. The method of claim 10, wherein:
the motorized locomotion system of each AGV further comprises two sets of wheels; and
the plurality of support members of each AGV are disposed on an underside of the vehicle body between the two sets of wheels.

12. The method of claim 10, wherein the plurality of support members of each AGV are removably affixed to the vehicle body.

13. The method of claim 10, wherein the plurality of support members of each AGV are pivotably affixed to the vehicle body for folding the support members into the vehicle body or are configured for retraction into the vehicle body.

14. The method of claim 10, wherein the plurality of slots of each AGV comprise:
a first set of slots disposed on an underside of the body and extending in a first direction; and
a second set of slots disposed on the underside of the body and extending in a second direction that is perpendicular to the first direction.

15. The method of claim 10, further comprising charging of the power source of the AGV.

16. The method of claim 10, further comprising locking the AGV to the at least one set of fork arms.

17. A system for facilitating the transport of autonomous ground vehicles at distribution centers and shopping facilities, the system comprising:
at least one autonomous ground vehicle (AGV), each AGV comprising:
a vehicle body;
a motorized locomotion system configured to facilitate movement of the AGV;
a navigational system for guiding the movement of the AGV;
a power source disposed in the vehicle body and configured to energize movement and operation of the AGV;
a plurality of support members defining slots disposed on the vehicle body, the slots configured for reception of fork arms therein for moving the AGV;
a merchandise storage area configured to facilitate transport of merchandise; and
an AGV control circuit operatively coupled to the motorized locomotion system, the navigational system, and the power source, the control circuit configured to operate and move the AGV.

18. The system of claim 17, wherein:
the motorized locomotion system of each AGV further comprises two sets of wheels; and
the plurality of support members of each AGV are disposed on an underside of the vehicle body between the two sets of wheels.

19. The system of claim 17, wherein the plurality of support members of each AGV are removably affixed to the vehicle body, are pivotably affixed to the vehicle body for folding the support members into the vehicle body, or are configured for retraction into the vehicle body.

20. The system of claim 17, wherein the plurality of slots of each AGV comprise:
a first set of slots disposed on an underside of the body and extending in a first direction; and
a second set of slots disposed on the underside of the body and extending in a second direction that is perpendicular to the first direction.
